(19) United States
(12) Patent Application Publication
(10) Pub. No.: US 2017/0188548 A1
(43) Pub. Date: Jul. 6, 2017

(54) METHODS FOR SELECTING A PETFOOD PROVIDING A SATISFYING FEEDING EXPERIENCE UPON CONSUMPTION BY PETS

(71) Applicant: SPECIALITES PET FOOD, Elven (FR)

(72) Inventors: Julien ROGUES, Lannion (FR); Christelle TOBIE, Saint-Ave (FR)

(73) Assignee: SPECIALITES PET FOOD, Elven (FR)

(21) Appl. No.: 15/314,007

(22) PCT Filed: May 15, 2015
(86) PCT No.: PCT/EP2015/060800

§ 371 Date: Nov. 25, 2016

(30) Foreign Application Priority Data
May 26, 2014 (EP) 14305779.2

(51) Int. Cl. A01K 29/00; A23K 50/40; A01K 5/02

(52) U.S. Cl. CPC A01K 29/005; A01K 5/02; A23K 50/40

(57) ABSTRACT

The present Invention provides methods for selecting a petfood providing a satisfying feeding experience upon consumption by pets through the determination of a Happiness Index (HI) for said petfood. Said HI is calculated via a specific analysis of data collected in a pet feeding trial. The present Invention further concerns a method for providing a satisfying feeding experience to a pet, by feeding said pet with a thus selected petfood.

The present invention relates to the general technical field of methods to measure pet's feeding enjoyment.

More specifically, the present invention provides methods for selecting a petfood providing a satisfying feeding experience upon consumption by pets through the determination of a Happiness Index (HI) for said petfood. Said HI is calculated via a specific analysis of data collected in a pet feeding trial.

The present invention further concerns a method for providing a satisfying feeding experience to a pet, by feeding said pet with a thus selected petfood.

### BACKGROUND OF THE INVENTION

The definition of petfood palatability has grown complex over the past few years, taking into account new dimensions such as the pet owner's perception. Currently, two main methods are commonly used for the purpose of evaluating a petfood's palatability. The first one is the versus or two-pan test, designed to evaluate the preference of the animal for one or the other of the two petfood products tested. This method is proven to be very efficient and reliable for discerning differences; it is a relevant and essential approach in petfood product development. However, the versus test design is quite different from a real-life in-home situation, and therefore yields limited information as to the pet owner's perception. The second common approach is the acceptability measurement, also called monadic testing or one-bowl testing. The main purpose of this evaluation is to confirm the animal's appreciation of the petfood product, and it is often used in the final steps of product development. This method is also sometimes used to evaluate the palatability of a petfood, but its low sensitivity is a clear limitation to this usage.

Thus, reliable and accurate methods for evaluating a petfood's palatability wherein the pet owner's perception is taken into account, are of high interest in the petfood market. Indeed, both good palatability of a petfood and a positive emotional reaction of a pet fed with this petfood, are important to objectively conclude that the pet is satisfied or enjoyed with this petfood. These both characteristics can be referred to as the “emotional palatability” of a petfood.

There is thus a need in the art for methods enabling assessment of pet's feeding enjoyment.

Based on their expertise, the Inventors designed methods allowing for the first time to reliably and objectively measure pet's feeding enjoyment through the calculation of an innovative index, the so-called Happiness Index (HI). With this index, the Inventors make it possible to globally characterize the pet's satisfaction vis-à-vis a petfood, to score different petfoods and to compare their respective “emotional palatability”.

### SUMMARY OF THE INVENTION

The present invention thus provides a method for assessing the “emotional palatability” of candidate petfoods. In the method of the invention, a Happiness Index (HI) is calculated using data collected in a pet feeding trial, said HI being indicative of the petfood's “emotional palatability”.

An object of the present invention concerns a method for selecting a petfood providing a satisfying feeding experience upon consumption by pets through the determination of a HI for said petfood.

A further object of the present invention relates to a method for providing a satisfying feeding experience to a pet.

### DETAILED DESCRIPTION OF THE INVENTION

### Definitions

In the present disclosure, ranges are stated in shorthand, so as to avoid having to set out at length and describe each and every value within the range. Any appropriate value within the range can be selected, where appropriate, as the upper value, lower value, or the terminus of the range. For example, a range of 0.1-1.0 represents the terminal values of 0.1 and 1.0, as well as the intermediate values of 0.2, 0.3, 0.4, 0.5, 0.6, 0.7, 0.8, 0.9, and all intermediate ranges encompassed within 0.1-1.0, such as 0.2-0.5, 0.2-0.8, 0.7-1.0, etc.

As used throughout, the singular form of a word includes the plural, and vice versa, unless the context clearly dictates otherwise. Thus, the references “a”, “an”, and “the” are generally inclusive of the plurals of the respective terms. For example, reference to “a method” or “a petfood” includes a plurality of such “methods” or “petfoods”. Similarly, the words “comprise”, “comprises”, and “comprising” are to be interpreted inclusively. Likewise the terms “include”, “including” and “or” should all be construed to be inclusive. All these terms however have to be considered as encompassing exclusive embodiments that may also be referred to using words such as “consist of”.

The methods and products and other embodiments exemplified here are not limited to the particular methodologies and protocols that are described herein because, as the skilled artisan will appreciate, they may vary.

Unless defined otherwise, all technical and scientific terms, terms of art, and acronyms used herein have the meanings commonly understood by the skilled artisan in the field(s) of the invention, or in the field(s) where the term is used. Although any products, methods, or other means or materials similar or equivalent to those described herein can be used in the practice of the present invention, the preferred products, methods, or other means or materials are described herein.

As used herein, the term “palatability” refers to the overall willingness of a pet to eat a certain petfood. Whenever a pet shows a preference, for example, for one of two or more petfoods, the preferred petfood is more “palatable”, and has “enhanced palatability”. Such preference can arise from any of the pet's senses, but typically is related to, inter alia, taste, aroma, flavour, texture, smell and/or mouth feel. Different methods exist to determine a palatability effect. Examples of such methods involve exposure of pets to petfoods either simultaneously (for example, in side-by-side, free-choice comparisons, e.g., by measuring relative consumption of at least two different petfoods), or sequentially (e.g., using single bowl testing methodologies). Advantageously, at least two different methods may be used to consolidate the thus obtained results on the palatability effect of a given petfood.

By the term “a satisfying feeding experience”, it is meant herein a feeding experience which provides enjoyment, happiness, satisfaction to a pet and which can be reflected by a behavorial response of the pet exposed to a petfood that is commonly construed as positive.

A “satisfying feeding experience” for a pet consuming a petfood is equivalent to the existence of an “emotional palatability” of a petfood consumed by a pet, as described above.

A “behavioral response” may occur prior to, during, or following consumption of a petfood. It should be noted that it is not necessary that consumption of the petfood occurs as a pet may behaviorally respond to a petfood without consuming it. Non-limiting examples of behavioral responses include, the pet looks up, shakes head, shakes tail, sits down; the pet moves the petfood out of a petfood container; the pet dribbles petfood on the floor; the pet consumes the petfood; and combinations thereof.

Behavorial responses that can be “construed as positive” are, e.g., the pet licks and/or sniffs feeding bowl, licks lips, grooms face (Van den Bos, 2000).

The present invention is dedicated to any class of “pets” or “companion animals”, such as cats, dogs, rabbits, guinea pigs, ferrets, hamsters, mice, gerbils, birds, horses, cows, goats, sheep, donkeys, pigs, and the like. Preferably, the pets under consideration in the context of the present invention are cats and dogs. If desired, the invention can be tested to evaluate its suitability for use with different classes of animals that may be considered as companion animals.

As used herein, the term “petfood” or “food” or “diet” means a product or composition that is a “nutritionally-complete”, “nutritionally-balanced” or “complete and nutritionally-balanced food”.

A “nutritionally-complete”, “nutritionally-balanced”, or “complete and nutritionally-balanced food” is one that contains all known required nutrients for the intended recipient or consumer of the petfood, in appropriate amounts and proportions based, for example, on recommendations of recognized or competent authorities in the field of pet nutrition. Such petfoods are therefore capable of serving as a sole source of dietary intake to maintain life, without the addition of supplemental nutritional sources.

In the present context, a “candidate petfood” or “experimental petfood” is a petfood to be tested in the method of selection according to the present invention.

There are three main categories or classes of petfoods depending on their moisture content, which is either low or medium or high:
dry or low moisture-containing products (having less than about 14% moisture): they usually produce a crunching sound when chewed by pets; they are generally highly nutritious, may be inexpensively packaged (e.g., in bags or boxes), and are highly convenient to store and use; they are relatively shelf-stable and resistant to microbial or fungal deterioration or contamination;
canned or wet or high moisture-containing products (having more than about 50% moisture): typically high meat-containing products, they are usually costly to produce and package (mainly in cans); they are not shelf-stable when opened so that excess or unused wet food must be refrigerated to prevent microbial or fungal spoilage;
semi-moist or semi-dry or soft dry or soft moist or intermediate or medium moisture-containing products (having from about 14 to about 50% moisture): they are usually packaged in appropriate bags or boxes; they contain stabilizing agents and can thus be stored in the same way as dry products.

The term “kibble” used herein refers to particulate chunks or pieces formed by either a pelleting or extrusion process. Typically, kibbles are produced to give dry and semi-moist pet food. The pieces can vary in sizes and shapes, depending on the process or the equipment. For instance, kibbles can have spherical, cylindrical, oval, or similar shapes. They can have a largest dimension of less than about 2 cm for example.

The terms “chunk in jelly”, “chunk in gravy”, “loaf” as used herein refer to wet edible foodstuffs.

The term “treat” (or “biscuit”) means any food item that is designed to be fed to a pet, preferably at non-meal time, by the owner to help, promote or sustain a bonding process between a pet and its owner.

The term “food supplement” or “dietary supplement” or “supplement” means a product that is intended to be ingested in addition to the normal animal diet.

Conventional pet feeding trials to test petfoods are well known in the art. Such trials are designed to test petfoods on panels of pets. Examples thereof include “monadic tests” and “versus tests”.

In a “monadic test” or “monadic feeding trial” or “single-bowl test”, only one food is given to pets at one given time, giving thus access to the acceptability of this specific petfood by the pet. When several petfoods are presented sequentially using monadic testing, the preference for one petfood compared to the other can be established by comparing the sequentially-collected data.

As used herein, a “monadic-based feeding trial” is either a conventional monadic feeding trial or an adjusted monadic feeding trial in order to maximize reliability and sensitivity. Such an “adjusted” monadic feeding trial can be a monadic feeding trial wherein, e.g.:
Meal size is adjusted to individual pet needs (leading to the notion of “initial ration” as defined below); and/or
Data over more than one meal are collected and processed; and/or
Food orders are counterbalanced between meals when more than one food is tested.

A “two-bowl test” or “two-pan test” or “versus test” enables one to determine preference of pets for one petfood compared simultaneously to another. A “versus test” is based on the postulate whereby the more food consumed, the more palatable it is.

As used herein, the term “meal” corresponds to a period of time during which a food to be eaten is placed at the pet's disposal, that is when a pet is exposed to a petfood. It should be noted that a pet does not necessarily consume a petfood during a meal. Actually, during a meal, a pet can consume a petfood totally or in part only or not at all.

By the terms “all pets during the feeding trial”, it is herein referred to the entire pet panel involved in the feeding trial.

A “pet panel” or a “panel” means a gathering of a certain amount of pets to obtain enough data in order to perform palatability tests and to statistically analyze the thus obtained results, those pets being representative of a clearly defined population and being known for their specific characteristics.

The term “bowl” is used herein to designate a petfood container.

By the term “finished bowl”, it is meant herein:
For cats, a bowl wherein the amount of remaining food is less than 1 g;
For dogs, a bowl wherein the amount of remaining food is less than 2.5% of its initial ration.

The term “amount of food consumed (Q)” herein refers to the calculated difference between the weight of petfood at the beginning of the meal and the weight of petfood at the end of the meal.

The term “duration of a meal (D)” herein refers to the time period between the beginning of the meal (when the bowl of petfood is available to the pet) and the end of the meal (when the pet stops its consumption). If the pet does not consume during the meal, then D is not collected.

As used herein, the term “refusal” means when the amount of petfood consumed by a pet is lower than 1 g.

By the term “initial ration”, it is meant herein the petfood ration specifically adjusted to a given pet based on its usual food consumption and its daily energy requirements.

The terms “a reference level of consumption of a pet” mean herein the level of petfood usually consumed by the pet. This information is easily available to the pet owner who knows his/her pet very well.

As used herein, a “pet feeding system”, a “feeding system”, a “pet feeding device”, and a “feeding device” are equivalent terms to designate a system or device that is utilized to collect data during a feeding trial for use in calculating a Happiness Index (HI) of a petfood.

### DESCRIPTION OF THE INVENTION

A first aspect of the present invention relates to a method for selecting a petfood providing a satisfying feeding experience upon consumption by pets through the determination of a Happiness Index (HI) for said petfood, wherein said method comprises at least:
a) providing at least one candidate petfood;
b) testing said candidate petfood in a monadic-based feeding trial, whereby collecting at least the following measures for each pet involved in said trial:
   amount of petfood consumed (Q);
   duration of a meal (D);
c) calculating the following variables:
   FB=percentage of finished bowls;
   RF=percentage of refusals;
   CP=percentage of consumed petfood; and optionally:
      CS=consumption speed (in %/time unit); and
d) calculating a Happiness Index (HI) for said candidate petfood wherein said HI is selected from:
   d1) a Basic Happiness Index (HI₁) which is calculated using Equation (1):

HI₁=FB+CP−RF (Equation (1)); and
d2) a Fast Happiness Index (HI₂) which is calculated using Equation (2):

HI₂=FB+CP−RF+CS (Equation (2)); and
e) if HI₁≦105% or HI₂≦117%, then concluding that the candidate petfood does not provide a satisfying feeding experience upon consumption by pets and thus not selecting the candidate petfood; or
f) if HI₁>105% or HI₂>117%, then concluding that the candidate petfood provides a satisfying feeding experience upon consumption by pets and thus selecting the candidate petfood.
   Preferably, said step c) further comprises calculating the variable:
CC=comparison of consumption with a reference level of consumption of each pet (in %),
   and said step d) consists of calculating a Happiness Index (HI) for said candidate petfood wherein said HI is selected from, in addition to HI₁ and HI₂:
d3) a High-Consumption Happiness Index (HI₃) which is calculated using Equation (3):

HI₃=FB+CP−RF+CC (Equation (3)); and
d4) a Fast and High-Consumption Happiness Index (HI₄) which is calculated using Equation (4):

HI₄=FB+CP−RF+CS+CC (Equation (4)).

Then, when using HI₃ or HI₄, steps e) and f) above are as follows:
when pets are dogs:
   e1) if HI₃≦204% or HI₄≦218%, then concluding that the candidate petfood does not provide a satisfying feeding experience upon consumption by dogs and thus not selecting the candidate petfood; or
   f1) if HI₃>204% or HI₄>218%, then concluding that the candidate petfood provides a satisfying feeding experience upon consumption by dogs and thus selecting the candidate petfood;
when pets are cats:
   e2) if HI₃≦222% or HI₄≦232%, then concluding that the candidate petfood does not provide a satisfying feeding experience upon consumption by cats and thus not selecting the candidate petfood; or
   f2) if HI₃>222% or HI₄>232%, then concluding that the candidate petfood provides a satisfying feeding experience upon consumption by cats and thus selecting the candidate petfood.

Anyone of HI₁, HI₂, HI₃, and HI₄ provides information on the “emotional palatability” of a petfood for pets. However, HI₁ is considered as a first indication of this “emotional palatability”. HI₂ and HI₃ are considered as providing more accurate and reliable information than HI₁. And, HI₄ is considered as a yet better indication of the “emotional palatability” than HI₂ or HI₃. Thus, advantageously, one skilled in the art will prefer determining HI₄.

In the method according to the present invention, the thus calculated HI values are compared to appropriate HI thresholds. These HI thresholds were determined by the Inventors for each Equation (Equations (1), (2), (3), and (4)), and for either cats or dogs (see Tables 1 and 2 below), based on a statistical descriptive analysis of an internal database gathering the data collected upon testing a high number of commercially-available and experimental petfood products over a large number of trials (data not shown).

TABLE 1
Dog HI thresholds

| | Threshold | Threshold | Threshold | Threshold |
|---|---|---|---|---|
| | for HI₁ | for HI₂ | for HI₃ | for HI₄ |
| Threshold for | 105% | 117% | 204% | 218% |
| dogs | | | | |

TABLE 2
Cat HI thresholds

| | Threshold | Threshold | Threshold | Threshold |
|---|---|---|---|---|
| | for HI₁ | for HI₂ | for HI₃ | for HI₄ |
| Threshold for | 105% | 117% | 222% | 232% |
| cats | | | | |

In step b), an amount Q and a duration D are collected per pet and per meal, and this, for all pets and all along the feeding trial. So, per pet and per meal, it is collected a pair of (Q, D) values, and this is done for all pets and all along the feeding trial. Thus, once the feeding trial is completed, it has been collected, for each pet, as many pairs of (Q, D) values as meals, and this has been done for all pets.

In particular, Q can be expressed in g. Yet in particular, D can be expressed in minutes.

An example of procedure for performing a monadic-based feeding trial is as follows.

Operating Method of the Test for the Evaluation of One Petfood:
An appropriate amount of food is weighed out for each pet and placed in a feeding bowl. The amount offered enables the daily energy requirements of the pet to be met.
The bowl is presented to the pet in a feeding system comprising all necessary equipment to collect, automatically or not, and preferably record the relevant data.
Each pet has free access to its respective distributed food.
For one petfood, the meal can last from 10 minutes to 24 hours, depending on protocols, and can be repeated over several days and/or several times per day.
Only one petfood is available to the pet per meal.
Food is replaced with fresh food at the beginning of every meal.
Parameters studied: quantities of petfood consumed and temporal data associated with these quantities.

Statistical Analysis:
For comparing results obtained with in-home panel, a statistical analysis is performed, preferably a parametric analysis, yet preferably an analysis of variance with mixed effects if data are quantitative and a logistic regression with mixed effects if data are qualitative. Typically, a student's T-test for quantitative data or a chit for qualitative data is done from these models to study the differences of each criterion for one candidate petfood.

Typical significance levels for statistical tests are noted as below:

| | | |
|---|---|---|
| NS | not significant | (p > 0.05) |
| * | significant | (p ≦ 0.05) |
| ** | highly significant | (p ≦ 0.01) |
| *** | very highly significant | (p ≦ 0.001). |

In an embodiment, the FB variable is calculated in step c) as the sum for all pets and over all meals of the finished bowls per meal per pet, said sum being divided by the total number of meals for all pets over the feeding trial.

In an embodiment, the RF variable is calculated in step c) as the sum for all pets and over all meals of the refusals per meal per pet, said sum being divided by the total number of meals for all pets over the feeding trial.

In an embodiment, the CP variable is calculated in step c) as the mean for all pets and over all meals over the feeding trial, of the ratios calculated per meal per pet between the amount Q of petfood consumed and the initial ration.

In an embodiment, the CS variable is calculated in step c) as the mean for all pets and over all meals over the feeding trial, of the ratios calculated per meal per pet between CP and the duration D. In particular, CS is expressed in %/min.

In an embodiment, the CC variable is calculated in step c) as the mean for all pets and over all meals over the feeding trial, of the ratios calculated per meal per pet between the amount Q of petfood consumed and the level of petfood usually consumed by the pet per meal.

Alternative embodiments of the method of selection according to the present invention may be proposed, wherein one or more other variables are calculated, either instead of one or more of the variables set forth above (FB, RF, CP, CS, CC), or in addition to one or more of these variables FB, RF, CP, CS, and CC. Such other variables can be related to, e.g., temporal information and/or pet behavorial information.

In particular, Equations (1) to (4) above are encompassed by a more general Equation (5) as follows:

HI₅=α×FB+β×CP−γ×RF+δ×CS+ε×CC (Equation (5))

### Wherein

The variables FB, CP, RF, CS, CC are as defined above,
The coefficients α, β, γ, δ, and ε are each ranging from 0 to 1.

As an example, when α=β=γ=1 and δ=ε=0, then Equation (5)=Equation (1) and HI₅=HI₁.

As another example, when α=β=γ=δ=1 and ε=0, then Equation (5)=Equation (2) and HI₅=HI₂.

As another example, when α=β=γ=ε=1 and δ=0, then Equation (5)=Equation (3) and HI₅=HI₃.

As another example, when α=β−γ=δ=ε=1, then Equation (5)=Equation (4) and HI₅=HI₄.

One of ordinary skill in the art may contemplate providing one or more other equations and HI values, by using one or more other variables (preferably associated to appropriate coefficients ranging from 0 to 1) and/or by assigning an appropriate value ranging from 0 to 1 to anyone of the α, β, γ, δ, and ε coefficients, and/or to anyone of the appropriate coefficients associated to other variables.

In the context of the present invention, the monadic-based feeding trial is performed on a panel of preferably at least 20, more preferably at least 25, yet more preferably at least 30 pets, even yet more preferably at least 35 pets. For example, a panel of dogs typically comprises 36 dogs. As another example, a panel of cats usually comprises 40 cats.

Preferably, said monadic-based feeding trial is performed over at least 2 meals. In particular, for cats, the monadic-based feeding trial can advantageously be performed over at least 4 meals (that can in particular be distributed over 2 or 4 days).

Another aspect of the present invention concerns a method for providing a satisfying feeding experience to a pet, comprising at least:
Performing the method as described above, thereby selecting a candidate petfood that provides a satisfying feeding experience upon consumption by pets; and
Feeding a pet with said thus selected candidate petfood, thereby providing a satisfying feeding experience to said pet.

Petfoods represent a nutritionally balanced mixture containing proteins, fibres, carbohydrates and/or starch, fats. Such mixtures are well known to those skilled in the art, and their composition/formulation depends on many factors such as, for example, the desired food balance for the specific category of pets. In addition to these base elements, the food may include vitamins, minerals, and other additives such as seasonings, preservatives, and the like. Specific suitable amounts for each component in a food composition will depend on a variety of factors such as the species of pet consuming the composition, the particular components included in the composition, the age, weight, general health of the pet, and the like. Therefore, the component amounts may vary from one embodiment to another. The food balance, including the relative proportions of vitamins, minerals, lipids, proteins, and carbohydrates, is determined according to the known dietary standards in the veterinary field, for example by following recommendations of the National Research council (NRC), or the guidelines of the American Association of Feed Control Officials (AAFCO).

In practice, a pet feeding system or device is used in the pet feeding trial as defined in the method of selection according to the present invention. Typically, such a system can comprise one or more of:
a feeding area comprising a petfood container (or bowl);
a means for detecting and identifying a pet using the feeding area, this detection means being automatic or not;
weighing means for weighing the amount of petfood consumed by a pet in the feeding area;
a time collector;
a data collector, automatic or not, for collecting and recording data provided by anyone of the detection means, the weighing means, and the time collector; and
a data processor for calculating variables such as those defined above.

The feeding device can be associated with hardware and software for the storage of the data. The association may be through network interface or wireless connectivity.

In all aspects and embodiments of the present invention, the pets are selected from cats and dogs.

The present invention can be adapted to apply to treats or food supplements instead of nutritionally-complete foods.

Examples of treats for dogs are bones. Examples of treats for cats are stuffed pillows and chewable sticks. Treats may be nutritional or not.

Food supplements may be in any form, e.g., solid, liquid, gel, tablets, capsules, powder, and the like. Preferably, they are provided in convenient dosage forms. In some embodiments, they are provided in bulk consumer packages such as bulk powders, liquids, gels, or oils. In other embodiments, supplements are provided in bulk quantities to be included in other food items such as snacks, treats, supplement bars, beverages, and the like.

In particular, examples of variables that could be of interest with respect to treats are as follows:
FC=full consumption: percentage of pets having completely eaten the entire treat;
RF=percentage of refusals: percentage of pets having totally refused the treat (i.e., having not eaten the treat at all);
PC=partial consumption: percentage of pets having only partially eaten the treat;
CS=consumption speed and/or speed of approach (latency) from the moment when the pet owner handles and proposes the treat to the pet.

The present invention will be further described by reference to the following examples, which are presented for the purpose of illustration only and are not intended to limit the scope of the invention.

### EXAMPLES

### Example 1: Dog Example

Two products for dogs were tested by an expert dog panel at Panelis (Elven, France) and by an in home dog panel.

Both dog foods were commercially-purchased, nutritionally-balanced dry food compositions suitable for consumption by dogs (hereinafter referred to as “Product A” and “Product B”).

In order to measure the satisfaction of dogs, a monadic-based feeding trial was performed for each product by an expert panel of 34 dogs at the Panelis pet resort. This monadic-based feeding trial was repeated for two meals, and data were gathered.

After collecting the individual measures Q (amount of petfood consumed) and D (duration of the meal), the variables previously defined were calculated: FB (percentage of finished bowls), RF (percentage of refusals), CP (percentage of consumed petfood), CS (consumption speed (in %/minute)), and CC (comparison of consumption with a reference level of consumption of each dog (in %)). Determinations of Hs were done using Equations (1), (2), (3) or (4), and the values were compared to the above-defined thresholds for dogs (see Table 1 above).

As shown in Table 3 below, the calculated variables for each petfood were different for Product A and Product B. Better results for each variable were observed with Product B.

TABLE 3
Dog expert panel- Results for Variables

| | | | | | CS | CC (consumption |
|---|---|---|---|---|---|---|
| | | FB (% of | | CP (% | (consumption | comparison/ |
| Product | Number | finished | RF (% of | consumed | speed- | reference level - |
| name | of data | bowls) | refusals) | petfood) | %/min) | %) |
| Product A | 68 | 23.53 | 29.41 | 50.63 | 10.04 | 75.33 |
| Product B | 68 | 50.00 | 5.90 | 79.74 | 14.35 | 112.28 |

As shown in Table 4 below, the Hs determined using the Equations, were each lower for Product A than for Product B. A comparison of the obtained Hs to the defined thresholds for dogs (as indicated in Table 1 above) clearly shows that Product A did not obtain a HI value to be classified as a satisfying food for dogs. At the opposite, the Hs calculated for Product B make it be classified as conducting to feeding enjoyment and satisfaction of dogs.

TABLE 4
Dog expert panel - HI results

| Product name | HI₁ (%) | HI₂ (%) | HI₃ (%) | HI₄ (%) |
|---|---|---|---|---|
| Product A | 44.8 | 54.8 | 120.1 | 130.1 |
| Product B | 123.8 | 138.2 | 236.1 | 250.5 |

The two same products were tested by an in home panel comprising 240 dogs. The following variables were determined: FB, RF, and CP. As shown in Table 5 below, for the 3 variables, Product B obtained better results than Product A. A statistical analysis was performed and clearly showed that Product A and Product B were statistically different for the % of finished bowls (FB), the % of refusals (RF), the % of consumed petfood (CP). Product B was considered as providing more happiness and satisfaction to dogs than Product A.

The results of the in home dog panel are thus in line with those given by the expert panel.

This demonstrates that the method according to the invention provides a relevant, reliable and accurate means for selecting a petfood providing a satisfying feeding experience to pets based on the determination of a Happiness Index and its comparison to a predetermined threshold.

TABLE 5
In home dog panel - Results for Variables

| | | FB (% of | | CP |
|---|---|---|---|---|
| | Nb of | finished | RF (% of | (% consumed |
| Product name | data | bowls) | refusals) | petfood) |
| Product A | 240 | 35.73 | 8.06 | 67.68 |
| Product B | 240 | 45.57 | 4.43 | 72.36 |
| Statistical | | ** | ** | ** |
| significance | | | | |

### Example 2: Cat Example

Two products for cats were tested by an expert cat panel at Panelis (Elven, France).

Both cat foods were commercially-purchased, nutritionally-balanced dry food compositions suitable for consumption by cats (hereinafter referred to as

“Product C” and “Product D”).

In order to measure the satisfaction of cats, a monadic-based feeding trial was performed for each product by an expert panel of 35 cats at the Panelis pet resort. This monadic-based feeding trial was repeated for four meals, and data were gathered.

After collecting the individual measures Q (amount of petfood consumed) and D (duration of the meal), the variables previously defined were calculated: FB (percentage of finished bowls), RF (percentage of refusals), CP (percentage of consumed petfood), CS (consumption speed (in %/minute)), and CC (comparison of consumption with a reference level of consumption of each cat (in %)). Determinations of His were done using Equations (1), (2), (3) or (4), and the values were compared to the above-defined thresholds for cats (see Table 2 above).

As shown in Table 6 below, the calculated variables for each petfood were different for Product C and Product D. Better results for each variable were obtained with Product D.

TABLE 6
Cat expert panel- Variables results

| | | | | | CS | |
|---|---|---|---|---|---|---|
| | | FB (% of | | CP (% | (consumption | CC (consumption |
| Product | Number | finished | RF (% of | consumed | speed- | comparison/ |
| name | of data | bowls) | refusals) | petfood) | %/min) | reference level - %) |
| Product C | 140 | 8.78 | 2 | 63.00 | 8.71 | 85.61 |
| Product D | 140 | 36.25 | 0 | 82.64 | 11.31 | 117.31 |

As shown in Table 7 below, the His determined using the Equations, were each lower for Product C compared to Product D. A comparison of the obtained His to the defined thresholds for cats (as indicated in Table 2 above) clearly shows that Product C did not obtain a HI value to be classified as a satisfying food for cats. At the opposite, the His calculated for Product D make it be classified as conducting to feeding enjoyment and satisfaction of cats.

TABLE 7
Cat expert panel - HI results

| Product name | HI₁ (%) | HI₂ (%) | HI₃ (%) | HI₄ (%) |
|---|---|---|---|---|
| Product C | 69.8 | 78.5 | 155.4 | 164.1 |
| Product D | 118.9 | 130.2 | 236.2 | 247.5 |

### REFERENCE

“Taste reactivity patterns in domestic cats (Felis silvestris catus)” Van den Bos, R.; Meijer, M. K.; Spruijt, B. M.; Applied Animal Behaviour Science, 2000, 69, 149-168.

1.-13. (canceled)

14. A method for selecting a petfood providing a satisfying feeding experience upon consumption by pets through the determination of a Happiness Index (HI) for said petfood, wherein said method comprises at least:
a) providing at least one candidate petfood;
b) testing said candidate petfood in a monadic-based feeding trial, whereby collecting at least the following measures for each pet involved in said trial:
amount of petfood consumed (Q);
duration of a meal (D);
c) calculating the following variables:
FB=percentage of finished bowls;
RF=percentage of refusals;
CP=percentage of consumed petfood; and
optionally:
CS=consumption speed (in %/time unit); and
d) calculating a Happiness Index (HI) for said candidate petfood wherein said HI is selected from:
d1) a Basic Happiness Index (HI₁) which is calculated using Equation (1):
HI₁=FB+CP−RF (Equation (1)); and
d2) a Fast Happiness Index (HI₂) which is calculated using Equation (2):
HI₂=FB+CP−RF+CS (Equation (2)); and
e) if HI₁≦105% or HI₂≦117%, then concluding that the candidate petfood does not provide a satisfying feeding experience upon consumption by pets and thus not selecting the candidate petfood; or
f) if HI₁>105% or HI₂>117%, then concluding that the candidate petfood provides a satisfying feeding experience upon consumption by pets and thus selecting the candidate petfood.

15. The method according to claim 14, wherein said step c) further comprises calculating the following variable:
CC=comparison of consumption with a reference level of consumption of each pet (in %);
and wherein said step d) consists of calculating a HI for said candidate petfood, wherein said HI is selected from:
d1) HI₁;
d2) HI₂;
d3) a High-Consumption Happiness Index (HI₃) which is calculated using Equation (3):
HI₃=FB+CP−RF+CC (Equation (3)); and
d4) a Fast and High-Consumption Happiness Index (HI₄) which is calculated using Equation (4):
HI₄=FB+CP−RF+CS+CC (Equation (4)).

16. The method according to claim 15, wherein said pets are dogs and wherein, when using HI₃ or HI₄, steps e) and f) above are as follows:
e1) if HI₃≦204% or HI₄≦218%, then concluding that the candidate petfood does not provide a satisfying feeding experience upon consumption by dogs and thus not selecting the candidate petfood; or
f1) if HI₃>204% or HI₄>218%, then concluding that the candidate petfood provides a satisfying feeding experience upon consumption by dogs and thus selecting the candidate petfood.

17. The method according to claim 15, wherein said pets are cats and wherein, when using HI₃ or HI₄, steps e) and f) above are as follows:
e2) if HI₃≦222% or HI₄≦232%, then concluding that the candidate petfood does not provide a satisfying feeding experience upon consumption by cats and thus not selecting the candidate petfood; or
f2) if HI₃>222% or HI₄>232%, then concluding that the candidate petfood provides a satisfying feeding experience upon consumption by cats and thus selecting the candidate petfood.

18. The method according to claim 14, wherein said variable FB is calculated in step c) as the sum for all pets and over all meals of the finished bowls per meal per pet, said sum being divided by the total number of meals for all pets over the feeding trial.

19. The method according to claim 15, wherein said variable FB is calculated in step c) as the sum for all pets and over all meals of the finished bowls per meal per pet, said sum being divided by the total number of meals for all pets over the feeding trial.

20. The method according to claim 14, wherein said variable RF is calculated in step c) as the sum for all pets and over all meals of the refusals per meal per pet, said sum being divided by the total number of meals for all pets over the feeding trial.

21. The method according to claim 15, wherein said variable RF is calculated in step c) as the sum for all pets and over all meals of the refusals per meal per pet, said sum being divided by the total number of meals for all pets over the feeding trial.

22. The method according to claim 14, wherein said variable CP is calculated in step c) as the mean for all pets and over all meals over the feeding trial, of the ratios calculated per meal per pet between the amount Q of petfood consumed and the initial ration.

23. The method according to claim 15, wherein said variable CP is calculated in step c) as the mean for all pets and over all meals over the feeding trial, of the ratios calculated per meal per pet between the amount Q of petfood consumed and the initial ration.

24. The method according to claim 14, wherein said variable CS is calculated in step c) as the mean for all pets and over all meals over the feeding trial, of the ratios calculated per meal per pet between CP and the duration D.

25. The method according to claim 15, wherein said variable CS is calculated in step c) as the mean for all pets and over all meals over the feeding trial, of the ratios calculated per meal per pet between CP and the duration D.

26. The method according to claim 15, wherein said variable CC is calculated in step c) as the mean for all pets and over all meals over the feeding trial, of the ratios calculated per meal per pet between the amount Q of petfood consumed and the level of petfood usually consumed by the pet per meal.

27. The method according to claim 14, wherein said monadic-based feeding trial is performed on a panel of at least 20, preferably at least 25, more preferably at least 30 pets, yet more preferably at least 35 pets.

28. The method according to claim 15, wherein said monadic-based feeding trial is performed on a panel of at least 20, preferably at least 25, more preferably at least 30 pets, yet more preferably at least 35 pets.

29. The method according to claim 14, wherein said monadic-based feeding trial is performed over at least 2 meals.

30. The method according to claim 15, wherein said monadic-based feeding trial is performed over at least 2 meals.

31. The method according to claim 29, wherein said monadic-based feeding trial is performed over at least 4 meals when said pet is a cat.

32. The method according to claim 30, wherein said monadic-based feeding trial is performed over at least 4 meals when said pet is a cat.

33. A method for providing a satisfying feeding experience to a pet, comprising at least:
Performing the method according to claim 14, thereby selecting a candidate petfood that provides a satisfying feeding experience upon consumption by pets; and
Feeding a pet with said thus selected candidate petfood, thereby providing a satisfying feeding experience to said pet.

34. A method for providing a satisfying feeding experience to a pet, comprising at least:
Performing the method according to claim 15, thereby selecting a candidate petfood that provides a satisfying feeding experience upon consumption by pets; and
Feeding a pet with said thus selected candidate petfood, thereby providing a satisfying feeding experience to said pet.
